(19) United States
(12) Patent Application Publication
(10) Pub. No.: US 2011/0232106 A1
(43) Pub. Date: Sep. 29, 2011

(54) Trimmer Head with Drop-Down Reservoir for Ease of Loading

(75) Inventors: Jeff ANDREWS, Mesa, AZ (US); Robert PHILLIPS, Scottsdale, AZ (US); Allen W. CHRISTMANN, Phoenix, AZ (US); Terry J. THOMPSON, Mesa, AZ (US)

(73) Assignee: Desert Extrusion Corporation, Phoenix, AZ (US)

(21) Appl. No.: 12/729,493

(22) Filed: Mar. 23, 2010

(51) Int. Cl. A01D 34/416; A01D 34/412

(52) U.S. Cl. 30/276; 30/347

(57) ABSTRACT

An improved head for a vegetation trimmer has a drop-down line reservoir that remains in cooperation with the head housing when the reservoir is in a load position. The reservoir fits inside the head housing and is biased against the housing for secure use. The reservoir is rotated to unlock it from the housing, whereby it drops down to allow access to the line in the reservoir. A user can add, remove, and manipulate line as desired without the inconvenience of detachable pieces. The reservoir can be pushed back into the housing and locked into place for use. The reservoir can also be placed in an advance position and rotated to advance more line through line openings in the housing as needed.

### FIELD OF INVENTION

This invention relates to vegetation trimming devices. This invention relates particularly to an improved head for a vegetation trimmer.

### BACKGROUND

Vegetation trimmers typically have a trimmer head that is attached to a main shaft and connected to a motor. The trimmer head holds trimmer line, which may be either fixed-length segments of line or a spool of line that is fed through an eyelet or eyelets as needed. One advantage of spool trimmer heads over fixed-line heads is that there is no need to constantly replace the worn or broken line segments. Another advantage is that the entirety of the line can be used, while fixed-line heads contain a part of the line segment, and that part is never used to cut vegetation.

One disadvantage of most spool heads is that they must be taken apart to get access to and reload the spool. Most spool heads are spring-loaded to bias the spool in the correct position within a housing, and the heads have a bolt or screw attaching the spool to the housing. When the bolt is unscrewed, the bolt, spool, and spring fall out of the housing. Parts are frequently lost, and eventually the repeated screwing and unscrewing leads to replacement of worn out parts. Further, once the parts have fallen out of the housing it is difficult to reload the spool and push it back into place without disturbing the trimmer line's coil around the spool. An improved head that provides easier access to load the spool is needed.

Some known spool heads attempt to resolve this problem by allowing replacement line to be fed into the head through an eyelet. The end of the line typically fits into a catch and the spool is rotated, winding the line onto the spool. On these heads, the user cannot see the spool or guide the line onto the spool with his fingers. It is difficult to get the line properly positioned for winding, and the user cannot detect and fix winding problems, such as twists and crossovers that can damage the line or inhibit advance of the line for use. An improved head that allows the user to monitor the winding and manually fix winding problems is needed.

Therefore, it is an object of this invention to provide an improved vegetation trimmer head having a reservoir of line that can be reloaded without taking apart the head. It is a further object that the user be able to see the line as it is added to the reservoir. It is a further object that the user be able to manipulate the line in the reservoir with his fingers, as needed.

### SUMMARY OF THE INVENTION

An improved head for a vegetation trimmer has a drop-down line reservoir that remains in cooperation with the head housing when the reservoir is in a load position. The housing and reservoir are coaxial with each other and with the main shaft of the vegetation trimmer. The reservoir is an annular cylinder that fits around a shaft extending coaxially from the housing, the fit being loose enough to allow the reservoir to slide along the shaft. Flanges near the base of the shaft and on the inner surface of the reservoir prevent the reservoir from sliding completely off the shaft. A biasing member, preferably a spring, fits over the shaft between the reservoir and the top of the housing. The assembly allows the reservoir to be placed in three positions. In the use position, the reservoir is within the housing and biased from the housing by the spring. In the advance position, the reservoir remains within the housing and is manipulated so trimmer line may be advanced through one or more line openings in the housing, to the user's desired length. In the load position, the spring pushes the reservoir down the shaft until the flanges contact each other, leaving the reservoir outside the housing so line can be added, removed, or repositioned.

### BRIEF DESCRIPTION OF THE DRAWINGS

FIG. 1 is an exploded top perspective view of the preferred embodiment of the present invention.

FIG. 2 is an exploded bottom perspective view of the preferred embodiment of the present invention.

FIG. 3 is a cross-section of the preferred embodiment of the invention in the load position.

FIG. 4 is a top perspective close-up view of the cross-section of FIG. 3 showing the cooperation between the shaft flange and the arbor flange.

FIG. 5 is a cross-section of the preferred embodiment of the invention in the use position.

### DETAILED DESCRIPTION OF THE INVENTION

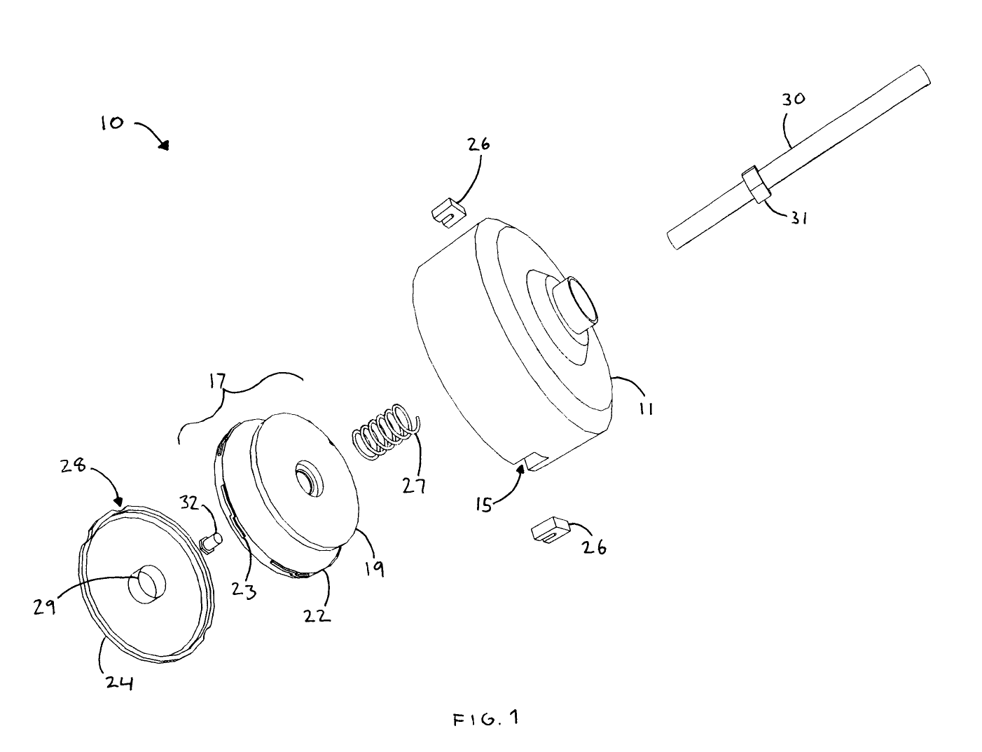

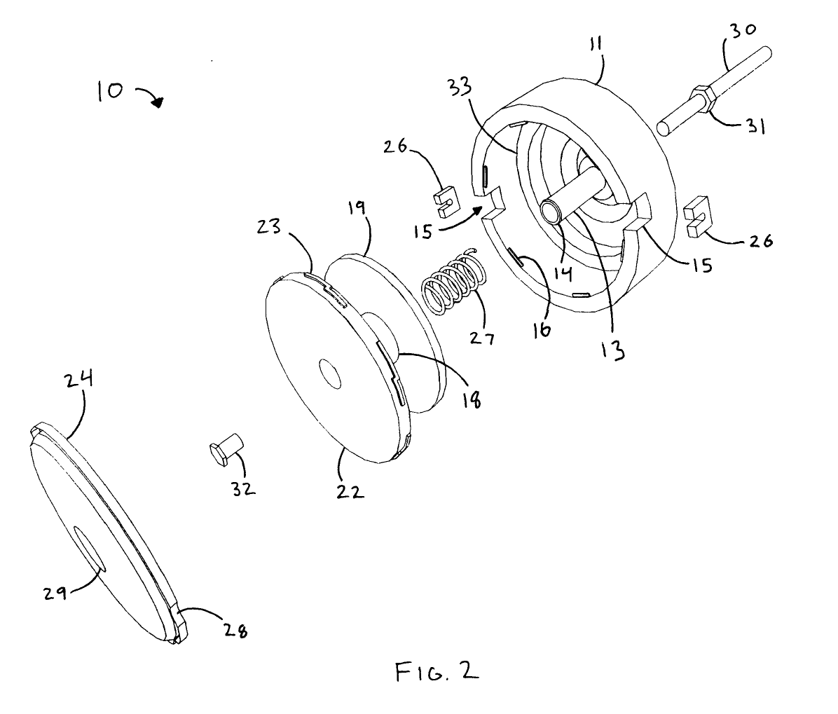

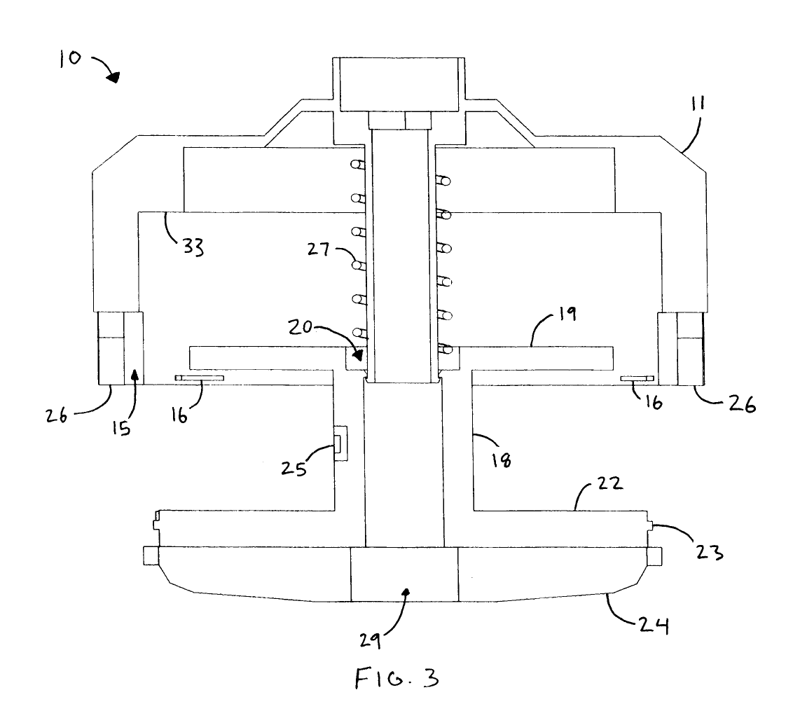

Referring to FIGS. 1 and 2, there is illustrated the preferred embodiment of the present invention, designated generally as 10, which is a trimmer head for fuel- or electricity-powered vegetation trimmer. The head 10 comprises a housing 11, a biasing member such as a spring 27, and a reservoir 17 that holds trimmer line and fits inside the housing 11, and is biased from the top of the housing by the biasing member. The housing 11 retains the trimmer line in the reservoir 17 and protects the trimmer line while the trimmer is in use. The housing 11 is preferably a die-cast metal cylinder, most preferably aluminum, but may alternatively be steel or molded plastic. The outer and inner diameters of the housing 11 are typical for commercial or residential vegetation trimmers, depending on the desired head 10 size. In the preferred embodiment, one or more notches 16 are integral with the housing 11 and positioned inside the housing 11 at the bottom of the housing 11. See FIG. 3. The notches 16 mate with positioning pegs 23 on the reservoir 17 to retain the reservoir 17 inside the housing 11 as described below. The notches 16 are preferably substantially arrow-shaped, having a rectangular body and triangular or trapezoidal head that is wider than the body. Alternatively, the notches 16 may be other shapes that are capable of mating with the positioning pegs 23, such as circular, tear-shaped, rectangular, square, or a combination of shapes.

One or more line openings 15 are disposed through the housing 11. A line opening 15 may be a hole, such as an eyelet, or may be a larger void functioning as a mount for a grommet 26, as shown in FIGS. 1 and 2. One or more trimmer lines pass from the reservoir 17 through the line openings 15, which may have grommets 26 that protect the trimmer line from wearing and breaking. Grommets 26 are preferably u-shaped as illustrated, with the line openings 15 appropriately sized to retain the grommets 26 in the housing 11. In embodiments utilizing multiple line openings 15, the line openings 15 may be uniformly spaced around the circumference of the housing 11 so that the head 10 maintains an equalized weight balance as it spins at high speeds. The line openings 15 may be the same distance or different distances from the top of the housing 11. Preferably, there are two diametrically opposed coplanar line openings 15 in the housing 11.

The housing 11 includes a substantially cylindrical shaft 13 attached to or integral with the housing 11. Preferably, the shaft 13 is integral with the housing 11 and is cast simultaneously with the housing 11. Alternatively, the shaft 13 may be permanently or removably attached to the housing 11. While other attachment means may be used, an example of permanent attachment is by adhesive, and an example of removable attachment is by mate-and-lock threads cast or molded into the housing 11 and shaft 13. The shaft 13 is coaxial with the housing 11 and has a top end at the top of the housing 11 and a bottom end that is preferably substantially coplanar with the bottom of the housing 11. In alternative embodiments, the shaft 13 may be longer or shorter, respectively extending or being recessed from the bottom of the housing 11. The shaft 13 may be a solid cylinder but is preferably a rigid tube, allowing the trimmer's main shaft 30 to pass through it as described below.

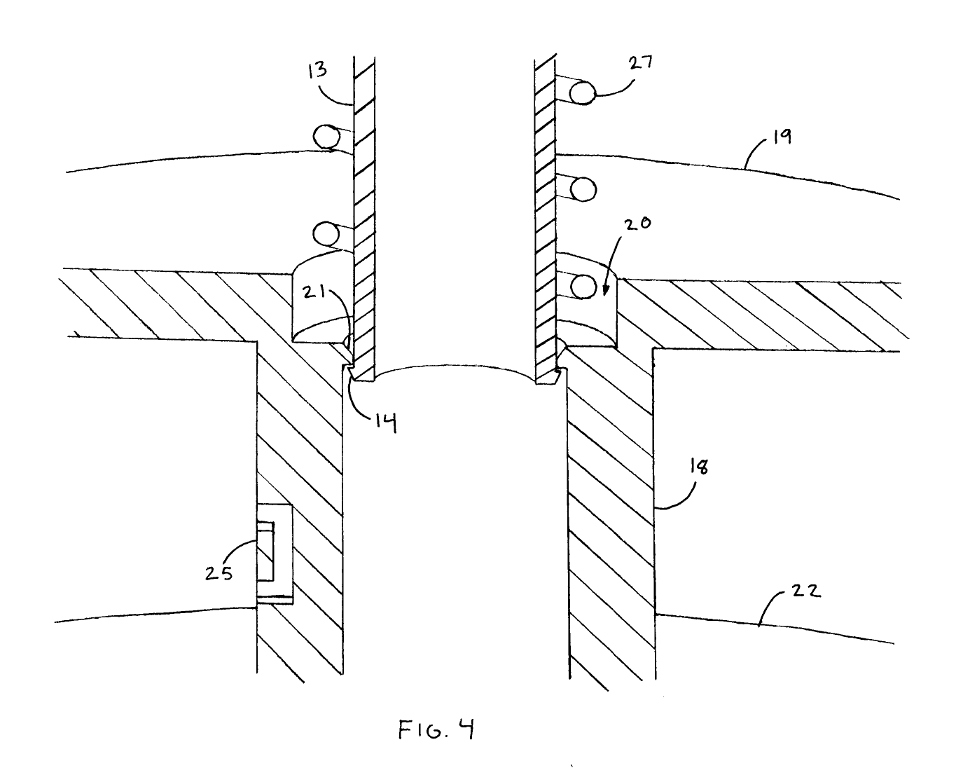

A shaft flange 14 encircles the shaft 13 at or near the bottom end. The shaft flange 14 is preferably integral with the shaft 13, but alternatively may be cast separately and permanently or removably attached to the shaft 13. The diameter of the shaft flange 14 is slightly larger than the diameter of the shaft 13, forming a collar that contacts the arbor flange 21 as described below. The shaft flange 14 may have any profile shape, such as triangular, rectangular, trapezoidal, or semicircular, so long as the top of the shaft flange 14 is able to engage the bottom of the arbor flange 21 to prevent the reservoir 17 from sliding off of the shaft 13. As shown in FIGS. 3 and 4, the shaft flange 14 preferably has a triangular profile, with the top of the shaft flange 14 being substantially perpendicular to the surface of the shaft 13. The shaft flange 14 then tapers to allow the arbor flange 21 to easily slide over the shaft flange 14 as described below. The tapering, which may be implemented in other shapes as well as the triangular profile, is preferred but not necessary.

The reservoir 17 comprises a rigid tubular arbor 18 attached to a top rim 19 and a bottom rim 22. The arbor 18 may be made of metal or one or more polymers, and is preferably nylon. A desired amount of trimmer line is wrapped around the arbor 18 and held vertically in place by the rims 19, 22. The outer diameter of the arbor 18 defines the surface onto which the trimmer line is wound. An anchor may be attached to or integral with the arbor 18, and the trimmer line may be secured to the anchor when it is first wound onto the arbor 18. In the preferred embodiment, the anchor is a hook 25 that is integral with and recessed in the arbor 18. The hook 25 is open in the direction opposite the winding of the trimmer line so that a loop of the trimmer line can be secured around the hook 25 and the trimmer line can be wound onto the arbor 18. The trimmer line is looped near its center and hooked onto the anchor. Once the trimmer line is wound, this provides two loose ends of trimmer line to be fed through the line openings 15. Alternatively, the anchor may be a hole that accepts an end of the trimmer line, or a hook that projects out from the surface of the arbor 18.

The arbor 18 may have a single inner diameter, so that the arbor 18 has a uniform wall thickness. This inner diameter is slightly larger than the diameter of the shaft flange 14. Preferably, however, a recess 20 is formed into the interior surface of the arbor 18 at the top end, as shown in FIGS. 3 and 4. This creates two inner diameters, where the first, smallest inner diameter is slightly larger than the diameter of the shaft flange 14, and the second inner diameter is slightly larger than the diameter of the spring 27. The spring 27 fits into the recess 20 to bias against the arbor 18 as described below. The depth of the recess 20 depends on the length of the arbor 18 and the desired amount of compression of the spring 27. Alternatively, no recess 20 is included on the arbor 18, and the biasing member biases against the top of the arbor 18 or against the top rim 19 described below.

The arbor 18 further comprises an arbor flange 21. The arbor flange 21 is positioned on the interior surface of the arbor 18, and may be vertically positioned anywhere between the top and about the midpoint of the arbor 18. The location of the arbor flange 21 determines how far the reservoir 17 will protrude from the housing 11 when the head 10 is placed in the load position as described below. Specifically, the closer to the top of the arbor 18 the arbor flange 21 is placed, the less of the reservoir 17 will be exposed in the load position. In the preferred embodiment, the arbor flange 21 is integral with the interior surface of the arbor 18. Alternatively, the arbor flange 21 may be separately manufactured and permanently or removably attached to the arbor 18. The diameter of the arbor flange 21 is slightly larger than the diameter of the shaft 13, but smaller than the diameter of the shaft flange 14. The arbor flange 21 may have any profile shape, such as triangular, rectangular, trapezoidal, or semicircular, so long as the bottom of the arbor flange 21 is able to engage the top of the shaft flange 14 to prevent the reservoir 17 from sliding off of the shaft 13. As shown in FIG. 4, the arbor flange 21 preferably has a trapezoidal profile, with the bottom of the arbor flange 21 being substantially perpendicular to the interior surface of the arbor 18. The arbor flange 21 tapers to allow the shaft flange 14 to easily slide over the arbor flange 21, placing the reservoir 17 in cooperation with the housing 11. See FIG. 4. The tapering, which may be implemented in other shapes as well as the trapezoidal profile, is preferred but not necessary.

The top rim 19 is attached to or integral with the arbor 18 at the top of the arbor 18. The top rim 19 is a rigid annular disc, preferably made of the same material as the arbor 18. The outer diameter of the top rim is small enough to fit into the housing 11, but large enough to retain a full reservoir of trimmer line. The inner diameter is aligned with the outer diameter of the arbor 18. The bottom rim 22 is also a rigid annular disc and is attached to or integral with the arbor 18 at the bottom of the arbor 18. The outer diameter of the bottom rim 22 is slightly smaller than the inner diameter of the housing 11, and the inner diameter is aligned with the outer diameter of the arbor 18. A series of positioning pegs 23 are spaced around the circumference of the bottom rim 22 on its outer surface, as shown in FIGS. 1 and 2. The positioning pegs 23 mate with the notches 16 on the interior surface of the housing 11 to hold the reservoir 17 inside the housing 11 in the use and advance positions described below.

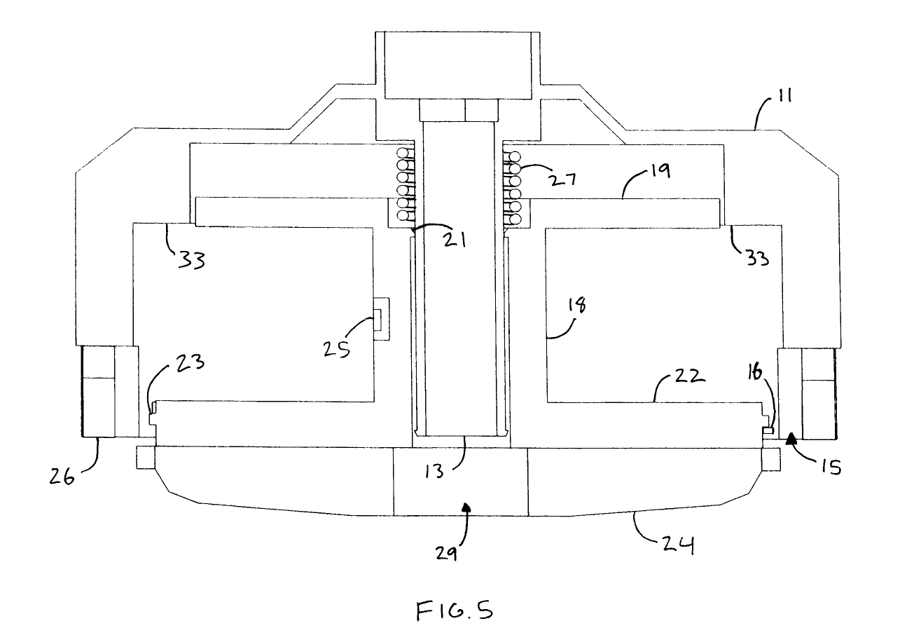

A base 24 is permanently or removably attached to the reservoir 17 at the bottom of the bottom rim 22. The base 24 may be the same material as the parts of the reservoir 17, but is preferably nylon and creates a protective shield against the ground and other surfaces when the vegetation trimmer is in use. The diameter of the base 24 preferably coincides with the outer diameter of the bottom rim 22, but alternatively may be smaller or slightly larger than the bottom rim 22. The base 24 may be circular, with a rounded profile as shown in FIGS. 3 and 5. The base 24 may have an aperture 29 through which the locking screw 32 and main shaft 30 may be accessed. Alternatively, the base 24 may be annular, allowing access to the shaft 13 with the base 24 attached. One or more grips 28 may be formed into the base 24. The user may rest his fingers on the grips 28 to get a firm hold on the reservoir 17 in order to move it between positions, or to rotate it as the user loads line into the reservoir 17.

A biasing member fits inside the housing 11 between the top of the housing 11 and the reservoir 17. The biasing member is preferably a spring 27 that fits around the shaft 13, but alternatively may be any resilient material that can be positioned to push the reservoir 17 out of the housing 11 in the load position. In the preferred embodiment, the spring 27 is slid over the shaft 13, and then the shaft 13 is slid into the arbor 18 until the arbor flange 21 slides over the shaft flange 14. At this point, the spring 27 fits into the recess 20 in the arbor 18. In alternative embodiments, the spring 27 may bias against the top rim 19 instead of the arbor 18. The preferred spring 27 has length and compression properties so that the spring 27 is slightly compressed when the head 10 is in the load position, wherein the arbor flange 21 is in contact with the shaft flange 14 and the reservoir 17 is in its most exposed position. See FIG. 3. The compression in this position is sufficient to keep the flanges 14, 21 pressed into contact with each other. Further, the preferred spring 27 is substantially or fully compressed in the use position, wherein the mating of the positioning pegs 23 and notches 16 secure the reservoir 17 inside the housing 11. See FIG. 5.

A line guard 33 may be attached to, but is preferably integral with, the housing 11. The line guard 33 is sized so that the top rim 19 of the reservoir 17 fits tightly inside the line guard 33 when the reservoir 17 is retracted into the housing 11. The line guard 33 may be flush with the top rim 19, or a small space may be left between the parts. The space between the line guard 33 and the top rim 19 is small enough to prevent trimmer line on the arbor 18 from being caught in the space above the top rim 19 when the head is in the use or advance position, described below.

The head 10 attaches to the main shaft 30 of the vegetation trimmer, which in turn is attached to a motor that drives rotation of the main shaft 30 and the head 10. The head 10 may be attached to the main shaft 30 using methods known in the art. Preferably, the main shaft 30 has a nut 31 that fits into a hex-shaped recess in the top of the housing 11. The main shaft 30 extends through the shaft 13, where a locking screw 32 having a head that is wider than the inner diameter of the shaft 13 screws into the end of the main shaft 30. When the locking screw 32 is tightened, the locking screw 32 and the nut 31 hold the head 10 in place on the main shaft 30. The main shaft 30, housing 11, spring 27, and reservoir are all substantially coaxial. If the base 22 is removable, it may be attached to the bottom of the reservoir 17 after the locking screw 32 is screwed into place.

The positions of the preferred head 10 are illustrated for a vegetation trimmer with a main shaft 30 that is rotated clockwise, from the bottom view, by the motor in order to cut vegetation. Referring to FIG. 3, from the use position, turning the reservoir 17 counter-clockwise releases the mate of the positioning pegs 23 and the notches 16. The spring 27 then pushes the reservoir 17 out of the housing 11 until the flanges 14, 21 contact each other. This fully extended position is the load position. The reservoir 17 may be freely rotated by the user's fingers, and the user can wind trimmer line onto the arbor easily, ensuring proper winding by visual inspection and manipulation by fingers. Starting from an empty reservoir 17, the user loops the trimmer line around the hook 25 and turns the reservoir 17 clockwise to wind the trimmer line onto the arbor. When fully wound, the two line ends are fed through the line openings 15 and the reservoir 17 is pushed into the housing and turned clockwise to lock it into the use position. It is contemplated that these rotational directions may be reversed, depending on the needs of the design.

FIG. 5 shows the preferred embodiment of the head 10 in the use position. The positioning pegs 23 are mated with the notches 16 and locked against the rotational direction of the head 10 when the vegetation trimmer is in use; that is, the design of the positioning pegs 23 and notches 16 prevent rotation of the reservoir 17 with respect to the main shaft 30 while the motor is operating. From the use position, the head 10 is placed in the advance position by pushing the reservoir 17 further into the housing 11, releasing the lock of positioning pegs 23 against the notches 16, and turning the reservoir 17 clockwise. Turning the reservoir 17 counter-clockwise from the use position causes the positioning pegs 23 to unlock and the reservoir 17 to drop down into the load position.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. A trimmer head for a vegetation trimmer, the trimmer head comprising:
a) a housing; and
b) a reservoir for containing an amount of trimmer line, the reservoir cooperating with the housing so that it may drop from a use position to a load position while remaining in cooperation with the housing.

2. The trimmer head of claim 1 wherein:
a) in the use position, the reservoir is positioned inside the housing; and
b) in the load position, the reservoir is positioned at least partially outside the housing so that a user can manipulate the trimmer line with the user's fingers.

3. The trimmer head of claim 1 further comprising a biasing member positioned between the housing and the reservoir, the biasing member being configured to push the reservoir down from the use position to the load position.

4. The trimmer head of claim 1 wherein the housing comprises a substantially cylindrical shaft positioned inside and coaxial with the housing.

5. The trimmer head of claim 4 wherein the reservoir slides along the shaft and fits inside the housing.

6. The trimmer head of claim 5 wherein the reservoir comprises a flange having a diameter that is larger than the shaft.

7. The trimmer head of claim 6 wherein the shaft comprises a shaft flange having a diameter that is larger than the diameter of the flange on the reservoir, and wherein the flange contacts the shaft flange to retain the reservoir in cooperation with the housing.

8. The trimmer head of claim 7 further comprising a biasing member positioned between the housing and the reservoir and configured to push the reservoir down the shaft until the flange contacts the shaft flange.

9. The trimmer head of claim 5 wherein the reservoir comprises:
a) a tubular arbor;
b) a top rim attached to the arbor; and
c) a bottom rim attached to the arbor;
the reservoir being substantially coaxial with the shaft so that the shaft passes partially or fully through the arbor.

10. The trimmer head of claim 9 wherein:
a) the reservoir further comprises an arbor flange attached to the interior surface of the arbor and having a diameter that is larger than the outer diameter of the shaft;
b) the shaft comprises a shaft flange attached to the outer surface of the shaft and having a diameter that is larger than the diameter of the arbor flange; and
c) contact between the arbor flange and the shaft flange retains the reservoir in cooperation with the housing when the arbor flange is above the shaft flange.

11. The trimmer head of claim 10 further comprising a biasing member positioned between the housing and the reservoir.

12. The trimmer head of claim 11 wherein the biasing member is compressed in the use position and is configured to decompress when the reservoir is moved from the use position to the load position, pushing the reservoir out of the housing until the arbor flange contacts the shaft flange.

13. The trimmer head of claim 12 wherein the biasing member is a spring.

14. The trimmer head of claim 13 wherein the spring fits around the shaft.

15. The trimmer head of claim 11 wherein:
a) the housing comprises one or more notches positioned near the bottom of the housing; and
b) the bottom rim comprises one or more positioning pegs configured to mate with the notches when the reservoir is in the use position.

16. The trimmer head of claim 15 wherein the reservoir is moved from the load position to the use position by pushing the reservoir up the shaft and into the housing, and rotating the reservoir in a first direction, with respect to the shaft, until the positioning pegs mate with the notches.

17. The trimmer head of claim 16 wherein the reservoir is moved from the use position to the load position by rotating the reservoir in a second direction opposite the first direction, with respect to the shaft, until the positioning pegs dislodge from the notches and the reservoir drops down until the arbor flange contacts the shaft flange.

18. The trimmer head of claim 11 wherein the housing further comprises one or more line openings through which trimmer line is passed from the reservoir out of the housing.

19. The trimmer head of claim 11 wherein the housing further comprises a plurality of line openings through which trimmer line is passed from the reservoir out of the housing, the line openings being uniformly spaced around the housing.

20. A trimmer head for a vegetation trimmer having a main shaft, the trimmer head comprising:
a) a substantially cylindrical housing coaxial with the main shaft, the housing comprising:
i. two line openings through which trimmer line passes out of the housing, the line openings being diametrically opposed on the housing; and
ii. a series of notches integral with the housing and uniformly spaced about the interior of the housing near the bottom of the housing;
b) a tubular shaft having a top end, a bottom end, an inner diameter larger than the main shaft, and an outer diameter, the shaft being attached to the housing at the top end and being coaxial with the housing;
c) a shaft flange positioned on the outer surface of the shaft at the bottom end of the shaft, the shaft flange having a top that is substantially perpendicular to the outer surface of the shaft;
d) a reservoir configured to fit inside the housing and to hold a desired amount of a desired trimmer line, the reservoir comprising:
i. a tubular arbor having a top end, a bottom end, an inner diameter, and an outer diameter, the inner diameter being larger than the diameter of the shaft flange;
ii. an arbor flange positioned on the interior surface of the arbor, the arbor flange having a bottom that is substantially perpendicular to the interior surface of the arbor, and having a diameter that is larger than the outer diameter of the shaft and smaller than the diameter of the shaft flange;
iii. an annular top rim attached to the arbor at the top end of the arbor; and
iv. an annular bottom rim attached to the arbor at the bottom end of the arbor, the bottom rim comprising a series of positioning pegs configured to mate with the notches such that the reservoir is held inside the housing when the user pushes the reservoir up the shaft and rotates the reservoir in one direction with respect to the shaft; and
e) a spring that fits around the shaft and biases against the housing and the reservoir, such that the spring is substantially compressed when the reservoir is in the use and advance positions, and when the user rotates the reservoir in the opposite direction with respect to the shaft, the spring decompresses, pushing the reservoir out of the housing until the bottom of the arbor flange contacts the top of the shaft flange.
